(19) United States
(12) Patent Application Publication
(10) Pub. No.: US 2008/0172677 A1
(43) Pub. Date: Jul. 17, 2008

(54) Controlling execution instances

(76) Inventors: Deepak Tripathi, Sunnyvale, CA (US); Sushanth Rai, Sunnyvale, CA (US); Sunil V. Rao, Santa Clara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/653,551

(22) Filed: Jan. 16, 2007

(51) Int. Cl. G06F 9/54; G06F 12/00

(52) U.S. Cl. 719/315; 707/200; 707/E17.005

(57) ABSTRACT

Methods, computer readable media, systems, and computing devices are provided for controlling execution instances. A method embodiment includes maintaining in a counter of a database, a count associated with a particular number of execution instances of a application registered in the database. The method includes setting for the counter, an upper number associated with a particular number of execution instances of the application allowed to be registered in the database. The method also includes receiving to the database, a request from the application to launch an execution instance of the application. The method further includes transmitting from the database to the application, a response to the request, based on the count and the upper number.

### BACKGROUND

In the field of computer software, software instructions can execute to direct a computing device to perform various tasks. Software instructions can be stored in a memory of a computing device and executed by a processor of the computing device. Related software instructions can be grouped together in their storage and execution. Such groupings are referred to by various names, such as a process, an application, a program, or other names.

Multiple groups of software instructions can sometimes run on the same computing device at the same time. For example, two different processes may both run simultaneously on one computer, taking turns being executed by the computer's processor. Further, multiple copies of the same group of software instructions can sometimes run on the same computing device at the same time. As an example, two copies of an application, each with their own set of data, may both run simultaneously on one computer, taking turns being executed by the computer's processor. Throughout this document, each running copy of a group of software instructions is referred to as an execution instance and the starting of the running is referred to as launching the execution instance.

In some situations it can be useful to prevent multiple execution instances from running simultaneously. For example, if a particular set of data can only be properly used by one program at a time, then it can be useful to prevent multiple execution instances of the program from running simultaneously. In a prior approach to these situations, a first execution instance of an application creates a lock file and subsequent execution instances check the lock file before launching. When the first execution terminates, it should remove the lock file. However, this prior approach can cause difficulties, such as naming conflicts, when other groups of software instructions use existing lock files. This prior approach also works poorly when a first execution instance creates a lock file/socket but terminates abnormally and fails to remove the lock file, thus inappropriately preventing other execution instances from launching.

### BRIEF DESCRIPTION OF THE DRAWINGS

FIG. 1 illustrates an example of a computing device suitable to implement embodiments of the present disclosure.

FIG. 2 illustrates an embodiment of a system of software elements used to control execution instances according to the present disclosure.

FIG. 3 illustrates an embodiment of a method of controlling execution instances according to the present disclosure.

### DETAILED DESCRIPTION

Embodiments of the present disclosure include methods, computer readable media, systems, and computing devices are provided for controlling execution instances. A method embodiment includes maintaining in a counter of a database, a count associated with a particular number of execution instances of a application registered in the database. The method includes setting for the counter, an upper number associated with a particular number of execution instances of the application allowed to be registered in the database. The method also includes receiving to the database, a request from the application to launch an execution instance of the application. The method further includes transmitting from the database to the application, a response to the request, based on the count and the upper number.

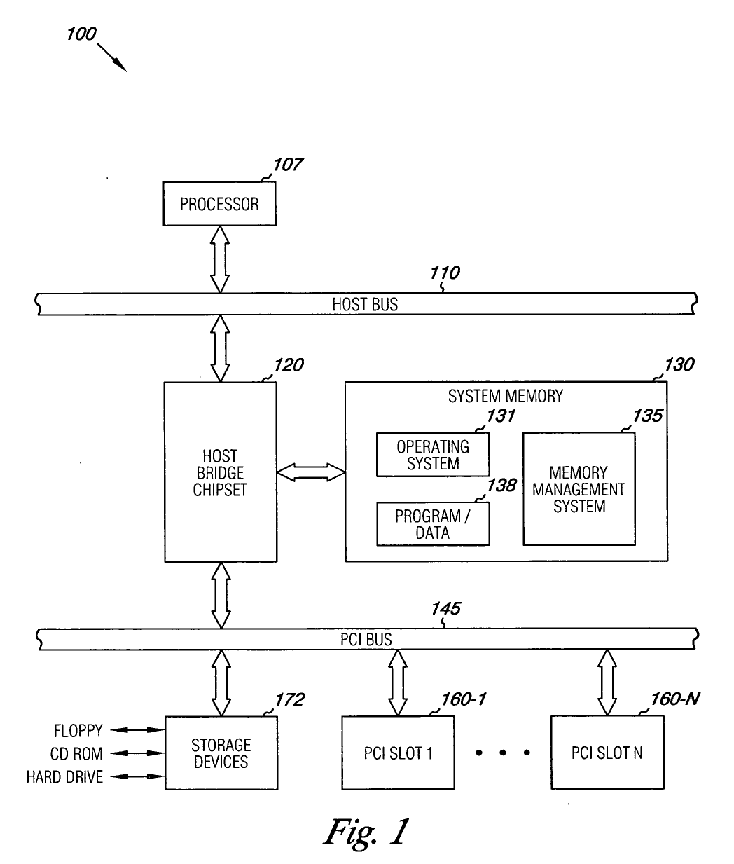

FIG. 1 illustrates an example of a computing device 100 suitable to implement embodiments of the present disclosure. The computing device 100 includes a processor 107, a host bus 110, a host bridge chipset 120, a system memory 130, a peripheral component interconnect (PCI) bus 145, PCI slots (e.g., slots for I/O circuit cards, controller cards, and other removable devices) 160-1 to 160-N (where N represents a scalable number), and one or more storage devices shown generally as 172.

The processor 107 represents a processing unit which can have various architectures. Embodiments of the disclosure can be implemented in a multi-processor or single processor computing system or device. Embodiments described herein can similarly be implemented in a distributed computing network environment, as the same are known and understood by one of ordinary skill in the art. The embodiments are not limited to the examples given herein.

The host bridge chipset 120 includes a number of interface circuits to allow the host processor 107 to access the system memory 130 and the PCI bus 145. The system memory 130 represents one or more mechanisms for storing information. For example, the system memory 130 may include non-volatile and/or volatile memories. Examples of these memories include flash memory, read only memory (ROM), random access memory (RAM), etc. The system memory 130 may be loaded with an operating system (OS) 131, e.g., in ROM. Examples of operating systems include, but are not limited to, Windows, Mac, Unix, Linux, etc. A basic input/output system (BIOS) is also stored in ROM in the system memory 130.

The system memory 130 further includes a memory management system 135, e.g., in RAM, and other programs and data 138. The system memory 130 may also contain additional software, such as processes or applications, as the same will be known and understood by one of ordinary skill in the art. The memory management system 135 includes elements in connection with software being executed by the processor 107. That is, as one of ordinary skill in the art will appreciate, the memory management system includes instructions for managing memory, memory data structures, etc.

The PCI slots 160-1 to 160-N provide interfaces to PCI devices. Examples of PCI devices can include printers, facsimiles, scanners, network interface devices, media interface devices, etc. Storage devices 172 can include floppy disks, CDs, hard drives, etc. Embodiments, however, are not limited to these examples.

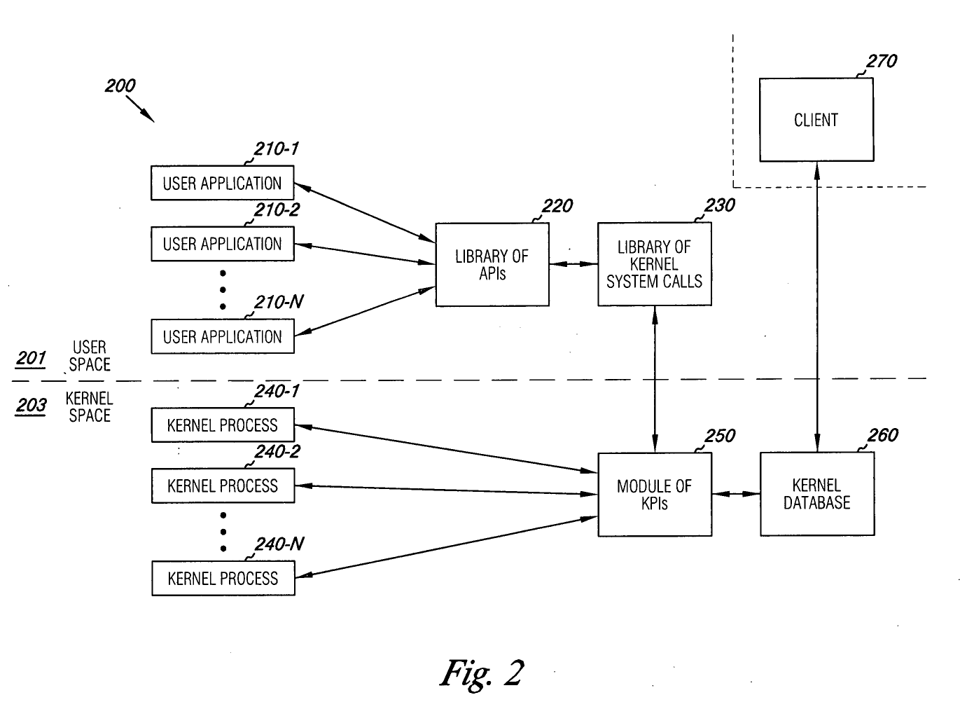

FIG. 2 illustrates an embodiment of a system 200 of software elements used to control execution instances according to the present disclosure. The system 200 includes software elements in a user space 201 and a kernel space 203. In the user space 201, the system 200 includes a first user application 210-1, a second user application 210-2, and an Nth user application 210-N (where N is a scalable number). The system 200 also includes a library of application programming interfaces (APIs) 220 and a library of kernel system calls 230.

In the kernel space 203, the system 200 includes a first kernel process 240-1, a second kernel process 240-2, an Nth kernel process 240-N, a module of kernel programming interfaces (KPIs) 250, and a kernel database 260. The system 200 is used in a system memory of a computing device (respectively referred to as “the memory” and “the computing device” in connection with the embodiment of FIG. 2), such as the system memory 130 of the computing device 100 of the embodiment of FIG. 1. In the embodiment of FIG. 2, block 270 represents a client to the computing device.

The user space 201 and the kernel space 203 are portions of the memory of the computing device. The user space 201 is a portion of the memory in which a user has more control over software than in the kernel space 203. In the user space 201, a user can select user applications, such as the user applications 210-1 through 210-N, to be launched or terminated. In the kernel space 203, software instructions can execute so that the kernel processes, such as the kernel processes 240-1 through 240-N, can launch, run, and terminate automatically, without direct control from a user. Various software instructions can execute to communicate between software elements in the user space 201 and software elements in the kernel space 203.

The user applications 210-1 through 210-N are software applications running in the user space 201. The user applications 210-1 through 210-N can be various types of software applications. For example, a user application can be a word processor, a spreadsheet, an e-mail application, a media player, etc. Although three user applications are shown in FIG. 2, embodiments of the present disclosure can include various numbers of user applications. The user applications 210-1 through 210-N are configured to communicate with the library of APIs 220.

The library of APIs 220 is a collection of groups of software instructions, with each group designed to perform one or more particular tasks. Software instructions can execute so that an API can facilitate an interface between groups of software instructions, such as applications, in the user space 201. For example, an API can facilitate an interface by providing a set of definitions. In this example, software instructions can execute so that the API can receive a communication from an application, redefine the communication by using the set of definitions, and transmit the redefined communication to another application. The library of APIs 220 is configured to communicate with the user applications 210-1 through 210-N and with the library of kernel system calls 230.

In the embodiment of FIG. 2, software instructions can execute so that the APIs in the library of APIs 220 can facilitate interfaces between the user applications 210-1 through 210-N and kernel system calls in the library of kernel system calls 230. In various embodiments, the library of APIs 220 can be associated with one or more of the user applications 210-1 through 210-N. For example, the user applications 210-1 through 210-N can be registered with the library of APIs 220, as will be understood by one of ordinary skill in the art.

The library of kernel system calls 230 is also a collection of groups of software instructions, with each group designed to perform one or more particular tasks. Software instructions can execute so that a kernel system call can call for a particular task to be performed in the kernel space. The library of kernel system calls 230 is configured to communicate with the library of APIs 220 and with the module of KPIs 250. In the embodiment of FIG. 2, software instructions can execute so that the kernel system calls in the library of kernel system calls 230 can call for one or more KPIs in the module of KPIs 250 to communicate with the kernel database 260 on behalf of one or more of the APIs in the library of APIs 220.

Software instructions can execute so that the kernel processes 240-1 through 240-N can also communicate with the module of KPIs 250. The kernel processes 240-1 through 240-N are software processes running in the kernel space 203. The kernel processes 240-1 through 240-N can be various types of kernel processes used to perform tasks in the kernel space 203 for an operating system, on behalf of user applications, or on behalf of other kernels. For example, software instructions can execute so that a kernel process can schedule software access to memory structures and hardware. Although three kernel processes are shown in FIG. 2, embodiments of the present disclosure can include various numbers of kernel processes.

The module of KPIs 250 is a kernel module that includes groups of software instructions, with each group designed to perform one or more particular tasks. Software instructions can execute so that a KPI can facilitate an interface between groups of software instructions, such as processes, in the kernel space 203. For example, a KPI can facilitate an interface by providing a set of definitions and by executing software instructions so that the KPI can receive a communication from one process, redefine the communication by using the set of definitions, and transmit the redefined communication to another process. The module of KPIs 250 is configured to communicate with the library of kernel system calls 230, with the kernel processes 240-1 through 240-N, and with the kernel database 260. In the embodiment of FIG. 2, software instructions can execute so that the KPIs in the module of KPIs 250 can facilitate interfaces between the kernel processes 240-1 through 240-N and the kernel database 260.

When the KPIs in the module of KPIs 250 are called by kernel system calls from the library of kernel system calls 230, software instructions can execute so that the KPIs in the module of KPIs 250 can also facilitate interfaces between the APIs in the library of APIs 220 and the kernel database 260. In various embodiments, the module of KPIs 250 can be associated with one or more of the kernel processes 240-1 through 240-N. For example, the kernel processes 240-1 through 240-N can be registered with the module of KPIs 250, as will be understood by one of ordinary skill in the art.

The kernel database 260 is a data structure which contains information about software on the computing device. The kernel database 260 includes information about execution instances for the user applications 210-1 through 210-N and the kernel processes 240-1 through 240-N. Software instructions can execute to modify the information in the kernel database 260. In various embodiments, these software instructions can be instructions in the kernel database 260, in KPIs, or in kernel processes, which may or may not be associated with the kernel database 260, the module of KPIs 250, and/or the kernel processes 240-1 through 240-N. The kernel database 260 is configured to communicate with the module of KPIs 250 and the client 270.

Software instructions can execute to use the kernel database 260 in the system 200 for controlling execution instances of software, such as the user applications 210-1 through 210-N and the kernel processes 240-1 through 240-N. In the embodiment of FIG. 2, software instructions can execute so that a user application, selected to be launched in the user space 201, transmits to the kernel database 260 a request to launch an execution instance of the user application. For example, software instructions can execute so that a user application in the user space 201 can transmit such a request to launch to the library of APIs 220, which can use a particular API in the library of APIs 220 to invoke a particular kernel system call in the library of kernel system calls 230, which can call a particular KPI in the module of KPIs 250, which can transmit the request to launch to the kernel database 260. In the embodiment of FIG. 2, software instructions can also execute so that, when an execution instance of a user application in the user space 201 terminates a notification is transmitted to the kernel database 260 indicating that an execution instance of that user application terminated. The notification of termination of a user application can be transmitted in a manner similar to the transmission of the request to launch by a user application, as described above.

Also in the embodiment of FIG. 2, software instructions can execute so that a kernel process selected to be launched in the kernel space 203 transmits to the kernel database 260 a request to launch an execution instance of the kernel process. For example, software instructions can execute so that a kernel process in the kernel space 203 can transmit a request to launch to the module of KPIs 250, which can use a particular KPI in the module of KPIs 250 to transmit the request to launch to the kernel database 260. In the embodiment of FIG. 2, software instructions can also execute so that, when an execution instance of a kernel process in the kernel space 203 terminates, a notification is transmitted to the kernel database 260 indicating that an execution instance of that kernel process terminated. The notification of termination of a kernel process can be transmitted in a manner similar to the transmission of the request to launch by a kernel process, as described above.

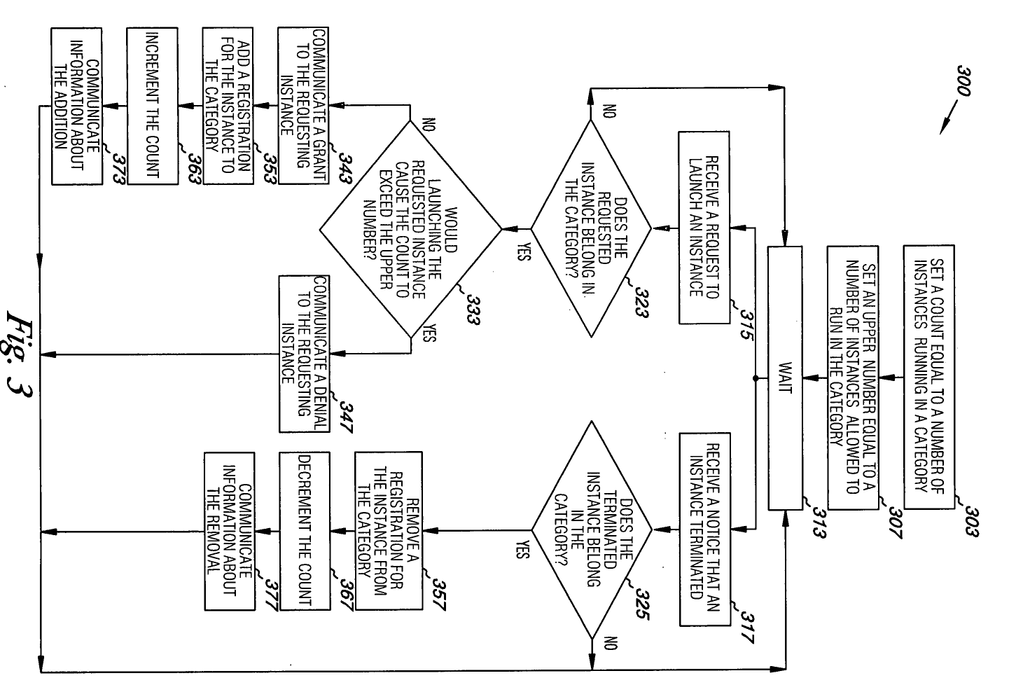

Software instructions can execute to determine whether to grant or deny a request to launch a user application or a kernel process, as described in connection with the embodiment of FIG. 3. Software instructions can also execute to communicate such a grant or denial to the requesting user application or kernel process, by using various communications, such as those described above. In various embodiments of the present disclosure, the kernel database 260 can be a single central database, used by all user applications and/or kernel processes on the computing device. These centralized embodiments are not susceptible to naming conflicts, since all applications and/or processes use the same single central database. However, in various embodiments of the present disclosure, more than one database can also be used for user applications and/or kernel processes on a computing device.

The client 270 is another computing device, different from the computing device which includes the memory with the user space 201 and the kernel space 203. The client 270 is configured to communicate with the kernel database 260. Although one client is shown in FIG. 2, embodiments of the present disclosure can include various numbers of clients. Software instructions can execute to communicate various information in the kernel database 260 about software execution instances in the computing device, to a client, such as the client 270, as described in connection with the embodiment of FIG. 3.

FIG. 3 illustrates an embodiment of a method 300 of controlling execution instances according to the present disclosure. For ease of reference, in connection with FIG. 3, execution instances are referred to as execution instances of user applications. However, the method 300 can also be applied to execution instances of kernel processes or other groups of software instructions, as will be understood by one of ordinary skill in the art. Also in connection with FIG. 3, references to the computing device refer to a single computing device on which the execution instances are requesting to be launched, are running, or are terminating. Various embodiments of the method 300 of FIG. 3 can be used with various embodiments of the system 200 of FIG. 2, as described herein.

At block 303, the method 300 includes setting a count equal to a number of application execution instances, in a particular category of software applications, which are running on the computing device. Software instructions can execute to set the count to equal the number of application execution instances which are running. In the embodiment of FIG. 3, a category of software applications can be based on one or more characteristics of software applications. For example, a category can include software applications which access a particular resource, such as an area of memory, in the computing device. Software instructions can execute to categorize an application into a particular category of software applications. In some embodiments of the present disclosure, each application on the computing device can be categorized into a single particular category of software applications.

In various embodiments of the present disclosure, software instructions can execute to set the count of block 303 as a count in an adjustable counter. For example, such a counter can be included in the kernel database 260, as described in connection with FIG. 2. Software instructions can also execute to adjust the count in the counter to maintain the count equal to the number of application execution instances, in the particular category of software applications, which are running on the computing device, in response to changes in the number which are running. For example, software instructions can execute to increment the count, as described in connection with block 363, or decrement the count, as described in connection with block 367.

In the setting of block 303, each application execution instance is considered separately, whether instances are from the same application or different applications. For example, if a first application is in a category of software applications and four execution instances of the first application are running on the computing device, then software instructions can execute to set the count at four to equal the total of four running application execution instances for the one application in the category. Also as an example, if a first application and a second application are in the same category of software applications, two execution instances of the first application are running on the computing device, and three execution instances of the second application are running on the same computing device, then software instructions can execute to set the count at five to equal the total of five running application execution instances for the two applications in the category.

In various embodiments, the count of block 303 can also be associated with a number of application execution instances, in a particular category of software applications, which are running on the computing device, without setting the count equal to the number. In some embodiments of the present disclosure, various algorithms can be applied to the count, so that the count represents the number of application execution instances without equaling the number of application execution instances, as will be understood by one of ordinary skill in the art. For example, an algorithm with a multiplying factor of two can be applied to the count, so that the count represents two times a number of application execution instances, in a particular category of software applications, which are running on the computing device. In this way, the count can be used to track the number of application execution instances without a one-for-one correspondence between the count and the number.

In some embodiments of the present disclosure, the count of block 303 can be associated with registrations for a number of application execution instances, which are running on the computing device. Software instructions can execute to register a number of application execution instances running simultaneously on the device. For example, software instructions can execute to perform these registrations by using a KPI, such as a KPI from the module of KPIs 250 in the embodiment of FIG. 2. In this example, software instructions can also execute to store these registrations in a database, such as the kernel database 260 in the embodiment of FIG. 2. Software instructions can execute to maintain and adjust these registrations as described, for example, at blocks 353 and 357. Software instructions can also execute to adjust the count of block 303, as described above, to maintain the association between the count and the registrations for the number of application execution instances, which are running on the computing device.

The method 300 also includes, at block 307, setting an upper number equal to a number of application execution instances, in a particular category of software applications, which are allowed to run simultaneously on the computing device. Software instructions can execute to set the upper number of application execution instances which are allowed to run simultaneously. For example, software instructions can execute to set the upper number by using a KPI, such as a KPI from the module of KPIs 250 in the embodiment of FIG. 2. In an embodiment in which the count of block 303 is in a counter, the upper number of block 307 can be an upper count number for the counter.

In some embodiments, the upper count number of block 307 can represent the number of allowable application execution instances without equaling the number of allowable application execution instances, as described above, in connection with the count of block 303. For example, software instructions can execute to set the upper number of block 307, to be associated with a number of application execution instances, in a particular category of software applications, which are allowed to run simultaneously on the computing device.

In various embodiments, the upper number of block 307 can be a fixed number or a variable number. The upper number can be fixed, for example, by a user of a user application in the particular category of software applications. The upper number can be variable, for example, based on resources available in the computing device. In this example, the upper number of execution instances can be reset based upon a change in availability of resources, such as memory, for simultaneously running application execution instances on the computing device. For instance, if less memory becomes available in the computing device, then the upper number can be reset to a lower value, to allow fewer application execution instances to run. Similarly, if more memory becomes available in the computing device, then the upper number can be reset to a higher value, to allow more application execution instances to run.

Block 313, wait, represents a connection point in the method 300. In the method 300, results from various elements direct the method to block 313, as depicted in FIG. 3. Software instructions can execute to perform this direction and to receive a request or a notification, as described at block 315 and 317.

At block 315, the method 300 includes receiving a request from a software application to launch an execution instance of the software application. The software application can be a user application, such as the user applications 210-1 through 210-N in the embodiment of FIG. 2. The request can be transmitted through various software elements to a kernel database, such as the kernel database 260, as described in connection with FIG. 2. Once a request to launch is received at block 315, software instructions can execute to direct the method to element 323.

The method 300 also includes, at element 323, a first decision regarding the request to launch received at block 315. At element 323, software instructions can execute to determine whether or not the application of the execution instance, for which the request to launch was received at block 315, belongs in the category, for which the count was set at block 303 and for which the upper number was set at block 307. Software instructions can execute to compare one or more characteristics of the application with one or more characteristics of the category, to determine whether or not the application belongs in the category. For example, if a category of software applications is defined by the characteristic of accessing a particular area of memory in the computing device, then software instructions associated with element 323 can execute to determine whether or not the application of the execution instance requesting launch also accesses the particular area of memory.

If software instructions associated with element 323 determine that the application of the execution instance requesting launch does not belong in the category (e.g. the “NO” output of element 323), then software instructions can execute to direct the method to block 313. If software instructions associated with element 323 determine that the application of the execution instance requesting launch belongs in the category (e.g. the “YES” output of element 323), then software instructions can execute to direct the method to element 333.

Element 333 includes a second decision regarding the request to launch received at block 315. Software instructions can execute to determine whether or not launching the requested application execution instance would cause the number of application execution instances in a category and running on the computing device, to exceed the number of application execution instances, which are allowed to run in the category and on the computing device. In the embodiment of FIG. 3, in which a count is maintained, at blocks 303, 363, and 367, for the number of currently running application execution instances, in the category of blocks 303, 307, and 323, on the computing device, software instructions for element 333 can execute to determine whether or not launching the execution instance of the application, requested at block 315, would cause the count to exceed the upper number, as described in block 307. This maintained count can be the count originally set at block 303, or as adjusted by blocks 363 and/or 367, during the performance of the method 300. Similarly, this upper number can be the upper number originally set at block 307, or as reset in various embodiments of the method 300 described above.

If software instructions associated with element 333 determine that launching the requested application execution instance would cause the count to exceed the upper number (e.g. the “YES” output of element 333), then software instructions can execute to direct the method to block 347. If software instructions associated with element 333 determine that launching the requested application execution instance would not cause the count to exceed the upper number (e.g. the “NO” output of element 333), then software instructions can execute to direct the method to block 343.

At block 343, the method 300 includes communicating a grant to the application from which the launch request was received at block 315. Software instructions can execute to communicate the grant in response to the launch request received at block 315. For example, the grant can be communicated by transmitting the grant from the kernel database 260 to the requesting application, as described in connection with FIG. 2. The execution instance of the requesting application can launch, in response to receiving the grant of block 343. As a result, the method 300 of FIG. 3 can be used to control execution instances of various applications, allowing them to launch in certain situations.

The method 300 also includes, at block 353, adding a registration for the execution instance of the application for which the request was received at block 315. Software instructions can execute to add the registration for the execution instance, in order to maintain registrations for application execution instances currently running on the computing device. For example, as described in connection with FIG. 2, a KPI from the module of KPIs 250 can update such registrations in the kernel database 260.

Block 363 includes incrementing the count of block 303. Software instructions can execute to increment the count, in order to maintain an association between the count, originally set at block 303, and the number of currently running application execution instances in the category of blocks 303, 307, and 323, on the computing device. For example, software instructions can execute to increment the count so that the count is equal to the number of currently running application execution instances in a category of software applications. The incrementing of block 363 can be performed by software instructions, such as instructions in a KPI from the module of KPIs 250 as described in connection with FIG. 2.

At block 373, the method 300 includes communicating information about the addition of the registration at block 353. As described in connection with FIG. 2, a client can be another computing device, different from the computing device in which the application execution instances are launching, running, and terminating. Such a client can be configured to communicate with the computing device of the embodiment of FIG. 3. In various embodiments, such a client can request information about application execution instances on the computing device. In these embodiments, software instructions can execute to transmit information about application execution instances to the client. For example, software instructions can execute to transmit to the client information about the addition of the registration at block 353. In this example, such updates can be transmitted from the kernel database 260 to the client 270, as described in connection with FIG. 2.

In various embodiments, additional information about execution instances can also be communicated to the client. For example, software instructions can execute to transmit to the client information about the number application instances currently running in a particular category, the existence of a particular category, etc. After the grant is communicated to the application at block 343, software instructions can execute to direct the method to block 313, to continue performing the method 300, as will be understood by one of ordinary skill in the art.

The method also includes, at block 347, communicating a denial to the application from which the launch request was received at block 315. Software instructions can execute to communicate the denial in response to the launch request received at block 315. For example, the denial can be communicated by transmitting the denial from the kernel database 260 to the requesting application, as described in connection with FIG. 2. The execution instance of the requesting application can be prevented from launching, in response to receiving the denial of block 347. As a result, the method 300 of FIG. 3 can be used to control execution instances of various applications, preventing them from launching in certain situations. After the denial is communicated to the application at block 347, software instructions can execute to direct the method to block 313, to continue performing the method 300, as will be understood by one of ordinary skill in the art.

Block 317 includes receiving a notification that a running execution instance of a software application terminated. The software application can be a user application, such as the user applications 210-1 through 210-N in the embodiment of FIG. 2. The notification can be transmitted through various software elements to a kernel database, such as the kernel database 260, as described in connection with FIG. 2. In embodiments of the present disclosure, software instructions can execute to provide such a notification of termination of an application execution instance, by using various flags, which can provide the notification when the execution instance terminates normally or abnormally. In various embodiments of the present disclosure, software instructions can execute to provide a notification of termination of an application execution instance in connection with a restart of the execution instance. Once a notification of termination is received at block 317, software instructions can execute to direct the method to element 323.

At element 325, the method 300 includes a decision regarding the notification received at block 317. At element 325, software instructions can execute to determine whether or not the application of the execution instance, for which the notification of termination was received at block 317, belongs in the category, for which the count was set at block 303 and for which the upper number was set at block 307. Software instructions can execute to compare one or more characteristics of the application with one or more characteristics of the category, to determine whether or not the application belongs in the category, as described in connection with element 323.

If software instructions associated with element 325 determine that the application of the execution instance requesting launch does not belong in the category (e.g. the “NO” output of element 325), then software instructions can execute to direct the method to block 313. If software instructions associated with element 325 determine that the application of the execution instance requesting launch belongs in the category (e.g. the “YES” output of element 325), then software instructions can execute to direct the method to block 357.

The method also includes, at block 357, removing a registration for the execution instance of the application for which the notification was received at block 317. Software instructions can execute to remove the registration for the execution instance, in order to maintain registrations for application execution instances currently running on the computing device. For example, as described in connection with FIG. 2, a KPI from the module of KPIs 250 can update such registrations in the kernel database 260.

Block 367 includes decrementing the count of block 303. Software instructions can execute to decrement the count, in order to maintain an association between the count, originally set at block 303, and the number of currently running application execution instances in the category of blocks 303, 307, and 323, on the computing device. For example, software instructions can execute to decrement the count so that the count is equal to the number of currently running application execution instances in a category of software applications. The decrementing of block 367 can be performed by software instructions, such as instructions in a KPI from the module of KPIs 250 as described in connection with FIG. 2.

At block 377, the method 300 includes communicating information about the removal of the registration at block 357. As described in connection with block 373, a client can be another computing device and can be configured to communicate with the computing device of the embodiment of FIG. 3. In various embodiments, such a client can request information about application execution instances on the computing device. In these embodiments, software instructions can execute to transmit information about application execution instances to the client. For example, software instructions can execute to transmit to the client information about the removal of the registration at block 357. In this example, such updates can be transmitted from the kernel database 260 to the client 270, as described in connection with FIG. 2. After the information about the removal is communicated to the client, software instructions can execute to direct the method to block 313, to continue performing the method 300, as will be understood by one of ordinary skill in the art.

Although specific embodiments have been illustrated and described herein, those of ordinary skill in the art will appreciate that an arrangement calculated to achieve the same techniques can be substituted for the specific embodiments shown. This disclosure is intended to cover all adaptations or variations of various embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the present disclosure require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A method comprising:
maintaining in a counter of a database, a count associated with a particular number of execution instances of an application registered in the database;
setting for the counter, an upper number associated with a particular number of execution instances of the application allowed to be registered in the database;
receiving to the database, a request from the application to launch an execution instance of the application; and
transmitting from the database to the application, a response to the request, based on the count and the upper number.

2. The method of claim 1, wherein, if launching the requested execution instance would cause the count to exceed the upper number, then transmitting from the database to the application, a denial which prevents the requested execution instance from launching.

3. The method of claim 1, wherein, if launching the requested execution instance would not cause the count to exceed the upper number, then transmitting from the database to the application, a grant which allows the requested execution instance to launch.

4. The method of claim 3, including:
launching the requested execution instance; and
registering the requested execution instance in the database; and
maintaining the count by incrementing the counter.

5. The method of claim 3, wherein the database controls launching for all execution instances of the application.

6. The method of claim 1, including:
receiving to the database, a notification from the application that an execution instance of the application terminated;
removing a registration of the terminated execution instance from the database; and
maintaining the count by decrementing the counter.

7. The method of claim 6, including receiving the notification when the terminated execution instance terminates abnormally.

8. The method of claim 6, wherein the terminated execution instance terminated in connection with a restart of the terminated execution instance.

9. A computer readable medium, having instructions for causing a device to perform a method, comprising:
setting an upper number of execution instances of an application allowed to run simultaneously on the device, by using a kernel programming interface for a kernel database;
registering in the kernel database a number of execution instances of the application running simultaneously on the device, by using a kernel programming interface for the kernel database;
receiving to the kernel database, a request to launch an execution instance of the application on the device; and
determining whether to launch the requested execution instance by comparing the number of execution instances running simultaneously with the upper number.

10. The medium of claim 9, wherein the method includes transmitting the request to launch as a kernel programming interface from a kernel module.

11. The medium of claim 10, wherein the method includes transmitting the kernel programming interface from the kernel module in response to a system call from a kernel library.

12. The medium of claim 11, wherein the method includes transmitting the system call from the kernel library in response to a request from a user-level application to launch an execution instance of the user-level application.

13. The medium of claim 9, wherein the method includes setting the upper number of execution instances as a fixed number, determined by a user of the application.

14. The medium of claim 9, wherein the method includes resetting the upper number of execution instances, based upon a change in availability of resources for simultaneously running execution instances of the application on the device

15. The medium of claim 9, wherein the method includes updating registrations in the kernel database from the registering, in response to a change in the number of execution instances of the application running simultaneously on the device.

16. The medium of claim 15, wherein the method includes transmitting information about the updating to a client of the device, in response to a request from the client.

17. A system, comprising:
a processor;
a memory, connected to the processor; and
program instructions storable in the memory and executable by the processor to:
receive a request to launch an execution instance of an application;
deny the request if launching the execution instance would cause a number of simultaneously running execution instances of the application to exceed a preset number; and
grant the request if launching the execution instance would not cause the number of simultaneously running execution instances of the application to exceed the preset number.

18. The system of claim 17, including instructions to:
categorize the application into a single category of applications based on a characteristic of the application;
deny the request if launching the execution instance would cause a number of simultaneously running execution instances of applications in the category to exceed a preset number; and
grant the request if launching the execution instance would not cause the number of simultaneously running execution instances of applications in the category to exceed the preset number.

19. The system of claim 18, including instructions to add to the category a registration of the execution instance, if the request is granted.

20. The system of claim 19, including instructions to remove from the category a registration of the execution instance, when the execution instance terminates.

21. The system of claim 20, including instructions to transmit information about the registration of the execution instance in the category, in response to a request from a client of the system.

22. A computing device, comprising:
a processor;
a memory, connected to the processor;
means for setting a particular number of execution instances of an application allowed to run simultaneously on the device; and
means for determining whether to launch a requested execution instance of the application based on the particular number of allowable execution instances.

23. The computing device of claim 22, including means for controlling whether the requested execution instance launches based on the determination of whether to launch.
